(19) United States
(12) Patent Application Publication
(10) Pub. No.: US 2019/0334962 A1
(43) Pub. Date: Oct. 31, 2019

(54) SMART INTERACTION METHOD, APPARATUS, DEVICE AND STORAGE MEDIUM

(71) Applicant: BAIDU ONLINE NETWORK TECHNOLOGY (BEIJING) CO., LTD., Beijing (CN)

(72) Inventor: Wenbo LI, Beijing (CN)

(21) Appl. No.: 16/508,419

(22) Filed: Jul. 11, 2019

(30) Foreign Application Priority Data
Sep. 17, 2018 (CN) 201811083217.8

(51) Int. Cl. H04L 29/06; H04L 29/08

(52) U.S. Cl. CPC H04L 65/403; H04L 65/1093; H04W 12/02; H04L 67/146; H04L 65/1069

(57) ABSTRACT

The present disclosure provides a smart interaction method, apparatus, device and a storage medium. The method includes: receiving an interaction request input by a first user, where the interaction request is used to request the first smart device under the first user in an interaction circle to interact with a second smart device under a second user in the interaction circle, and the interaction circle includes smart devices which are corresponding to a user social circle and which are under different users; and establishing an interactive connection with the second smart device according to the interaction request. According to the present disclosure, interaction privacy is improved.

### CROSS-REFERENCE TO RELATED APPLICATION

This application claims priority to Chinese Patent Application No. 201811083217.8, filed on Sep. 17, 2018, which is hereby incorporated by reference in its entirety.

### TECHNICAL FIELD

The present disclosure relates to the field of artificial intelligence technologies and, in particular, to a smart interaction method, apparatus, device, and a storage medium.

### BACKGROUND

With explosive development of artificial intelligence, an interaction requirement for an interaction between smart devices is proposed.

In the prior art, the interaction between smart devices relies entirely on a user connection. A smart device under User 1 may transmit information to User 2. Specifically, the smart device under User 1 transmits information to a smart device of User 2. After the smart device of User 2 receives the information, all smart devices under User 2 present the information. That is, the information transmitted by a smart device under a transmitting-end user is transmitted to a smart device of a receiving-end user, and is presented by all smart devices under a transmitting-end user of the receiving side.

However, since all smart devices under the receiving-end user present information transmitted by the smart device under the transmitting-end user, there is a problem on poor interaction privacy.

### SUMMARY

Embodiments of the present disclosure provide a smart interaction method, apparatus, device, and a storage medium, which are used to solve the problem on poor interaction privacy in the prior art.

In a first aspect, an embodiment of the present disclosure provides a smart interaction method performed by a first smart device, including:

receiving an interaction request input by a first user, where the interaction request is used to request the first smart device under the first user in an interaction circle to interact with a second smart device under a second user in the interaction circle, and the interaction circle includes smart devices which are corresponding to a user social circle and which are under different users; and

establishing an interactive connection with the second smart device according to the interaction request.

In a possibly implemented design, the interaction request includes: an identifier of the second user and an identifier of the interaction circle; and the establishing the interactive connection with the second smart device according to the interaction request includes:

determining the second smart device under the second user in the interaction circle according to the interaction request; and

establishing the interactive connection with the second smart device.

In a possibly implemented design, the receiving the interaction request input by the first user includes:

receiving an interaction request input by the first user on an interaction circle interaction page, where the interaction circle interaction page is a page that provides the user with a function for an interaction between the smart devices in the interaction circle.

In a possibly implemented design, before receiving the interaction request input by the first user, further including:

receiving an establishment request input by the first user, where the establishment request is used to apply for establishing the interaction circle; and

establishing the interaction circle according to the establishment request.

In a possibly implemented design, the receiving the establishment request input by the first user includes:

receiving an establishment request input by the first user on an interaction circle establishment page, where the interaction circle establishment page is a page that provides the user with a function for establishing the interaction circle.

In a possibly implemented design, after establishing the interaction circle according to the establishment request, further including:

receiving an invitation request input by the first user, where the invitation request includes an identifier of the second smart device, and the invitation request is used to invite the second smart device to join the interaction circle; and

inviting, according to the invitation request, the second smart device to join the interaction circle.

In a possibly implemented design, the receiving the invitation request input by the first user includes:

receiving an invitation request input by the first user on an interaction circle invitation page, where the interaction circle invitation page is a page that provides the user with a function for inviting a smart device.

In a possibly implemented design, before receiving the interaction request input by the first user, further including:

receiving an application request input by the first user, where the application request includes an identifier of the interaction circle, and the application request is used to request the first smart device to join the interaction circle; and

adding the first smart device to the interaction circle according to the application request.

In a possibly implemented design, the receiving the application request input by the first user includes:

receiving an application request input by the first user on an interaction circle application page, where the interaction circle application page is a page that provides the user with a function for adding a smart device to the interaction circle.

In a possibly implemented design, the method further includes:

receiving a management request input by the first user, where the management request is used to request management of the interaction circle; and managing the interaction circle according to the management request.

In a possibly implemented design, the receiving the management request input by the first user includes:

receiving a management request input by the first user on an interaction circle management page, where the interaction circle management page is a page that provides the user with a function for managing the interaction circle.

In a second aspect, an embodiment of the present disclosure provides smart interaction apparatus applied to a first smart device, including:

a receiving module, configured to receive an interaction request input by a first user, where the interaction request is used to request the first smart device under the first user in an interaction circle to interact with a second smart device under a second user in the interaction circle, and the interaction circle includes smart devices which are corresponding to a user social circle and which are under different users; and

an interaction module, configured to establish an interactive connection with the second smart device according to the interaction request.

In a possibly implemented design, the interaction request includes: an identifier of the second user and an identifier of the interaction circle;

the interaction module is specifically configured to:

determine the second smart device under the second user in the interaction circle according to the interaction request; and establish the interactive connection with the second smart device.

In a possibly implemented design, the receiving module is specifically configured to:

receive an interaction request input by the first user on an interaction circle interaction page, where the interaction circle interaction page is a page that provides the user with a function for an interaction between the smart devices in the interaction circle.

In a possibly implemented design, the receiving module is further configured to receive an establishment request input by the first user, where the establishment request is used to apply for establishing the interaction circle;

the apparatus further includes: an establishment module, configured to establish the interaction circle according to the establishment request.

In a possibly implemented design, the receiving module is configured to receive the establishment request input by the first user, specifically including:

receiving an establishment request input by the first user on an interaction circle establishment page, where the interaction circle establishment page is a page that provides the user with a function for establishing the interaction circle.

In a possibly implemented design, the receiving module is further configured to receive an invitation request input by the first user, where the invitation request includes an identifier of the second smart device, and the invitation request is used to invite the second smart device to join the interaction circle;

the apparatus further includes: an invitation module, configured to invite, according to the invitation request, the second smart device to join the interaction circle.

In a possibly implemented design, the receiving module is configured to receive the invitation request input by the first user, specifically including:

receiving an invitation request input by the first user on an interaction circle invitation page, where the interaction circle invitation page is a page that provides the user with a function for inviting a smart device.

In a possibly implemented design, the receiving module is further configured to receive an application request input by the first user, where the application request includes an identifier of the interaction circle, and the application request is used to request the first smart device to join the interaction circle;

the apparatus further includes: an adding module, configured to add the first smart device to the interaction circle according to the application request.

In a possibly implemented design, the receiving module is configured to receive the application request input by the first user, specifically including:

receiving an application request input by the first user on an interaction circle application page, where the interaction circle application page is a page that provides the user with a function for adding a smart device to the interaction circle.

In a possibly implemented design, the receiving module is further configured to receive a management request input by the first user, where the management request is used to request management of the interaction circle;

the apparatus further includes: a management module, configured to manage the interaction circle according to the management request.

In a possibly implemented design, the receiving module is configured to receive the management request input by the first user, specifically including:

receiving a management request input by the first user on an interaction circle management page, where the interaction circle management page is a page that provides the user with a function for managing the interaction circle.

In a third aspect, an embodiment of the present disclosure provides a smart device which is a first smart device, including:

a processor, and a memory for storing computer instructions, where the processor executes the computer instructions to perform the method according to any description in the first aspect above.

In a fourth aspect, an embodiment of the present disclosure provides a computer readable storage medium, when instructions in the storage medium are executed by a processor of a first smart device, the first smart device is enabled to perform the method according to any description in the first aspect above.

The smart interaction method, apparatus, device, and the storage medium provided in the embodiments of the present disclosure allow a first smart device to receive an interaction request input by a first user, where the interaction request is used to request the first smart device under the first user in an interaction circle to interact with a second smart device under a second user in the interaction circle, and the interaction circle includes smart devices which are corresponding to a user social circle and which are under different users; and allow the first smart device to establish an interactive connection with the second smart device according to the interaction request, so that an interaction between smart devices is not completely dependent on a user connection, but is related to the interaction circle. Specifically, a smart user device under a first user in an interaction circle may interact with a smart device under a second user in the interaction circle, instead of interacting with a smart device under a second user outside the interaction circle, thereby improving interaction privacy.

### BRIEF DESCRIPTION OF DRAWING(S)

In order to describe technical solutions in the embodiments of the present disclosure or the prior art more clearly, accompanying drawings used in the description of the embodiments or the prior art will be briefly described hereunder. Obviously, the described drawings are merely some embodiments of present disclosure. For persons of ordinary skill in the art, other drawings may be obtained based on these drawings without any creative effort.

FIG. 1A is a schematic diagram illustrating an application scenario of a smart interaction method according to an embodiment of the present disclosure;

FIG. 1B is a schematic diagram illustrating an interaction circle according to an embodiment of the present disclosure;

FIG. 2 is a flowchart illustrating a first embodiment of a smart interaction method according to an embodiment of the present disclosure;

FIG. 3 is a flowchart illustrating a second embodiment of a smart interaction method according to an embodiment of the present disclosure;

FIG. 4A-FIG. 4D are schematic diagrams illustrating interaction circle interaction pages according to embodiments of the present disclosure;

FIG. 5 is a schematic structural diagram illustrating an embodiment of smart interaction apparatus according to an embodiment of the present disclosure; and

FIG. 6 is a schematic structural diagram illustrating a smart device according to an embodiment of the present disclosure.

### DESCRIPTION OF EMBODIMENTS

In order to make objectives, technical solutions, and advantages of the embodiments of the present disclosure clearer, the technical solutions in the embodiments of the present disclosure will be described hereunder clearly and comprehensively with reference to the accompanying drawings in the embodiments of the present disclosure. Obviously, the described embodiments are only a part of embodiments of the present disclosure, rather than all embodiments of the present disclosure. All other embodiments obtained by persons of ordinary skill in the art based on the embodiments of the present disclosure without any creative effort shall fall into the protection scope of the present disclosure.

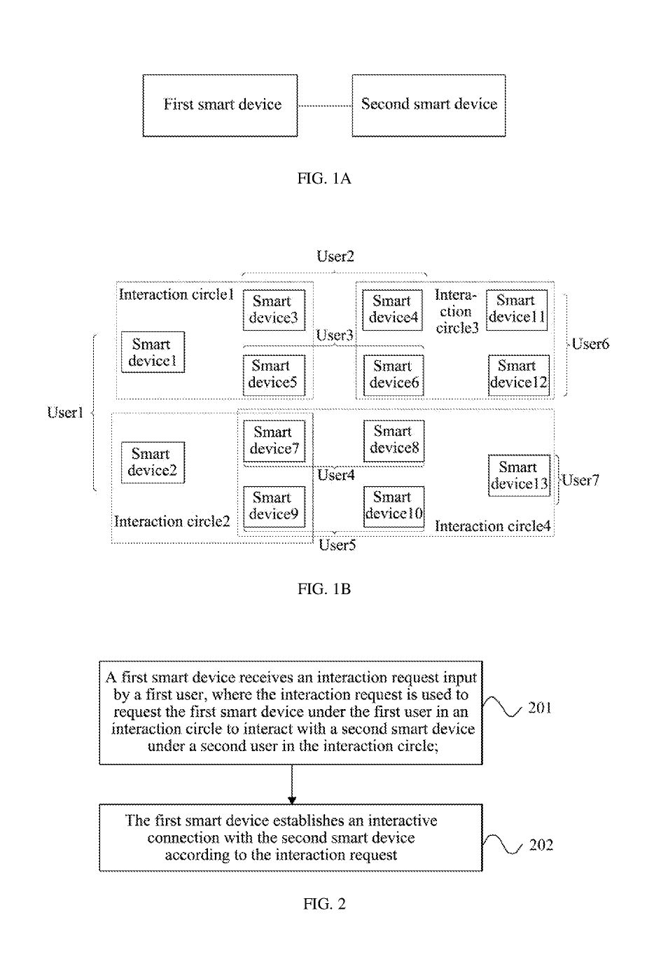

FIG. 1A is a schematic diagram illustrating an application scenario of a smart interaction method according to an embodiment of the present disclosure. As shown in FIG. 1A, the application scenario may include: a first smart device and a second smart device, where the first smart device is a smart device under a first user, and the second smart device is a smart device under a second user, and the first smart device and the second smart device are smart devices in one interaction circle.

It should be noted that the interaction circle may include one or more smart devices under the first user. When the interaction circle includes one smart device under the first user, the first smart device is the smart device; when the interaction circle includes more than one smart device under the first user, the first smart device may be one of the smart devices. Similarly, the interaction circle may include one or more smart devices under the second user. When the interaction circle includes one smart device under the second user, the second smart device is the smart device; when the interaction circle includes more than one smart device under the second user, the second smart device may be one or more of the smart devices. It could be understood that the interaction circle may also include a smart device under a further user other than the first user and the second user.

A smart device under the first user may be interpreted as a smart device of which the identifier has a binding relationship with an account of the first user. A smart device under the second user may be interpreted as a smart device of which the identifier has a binding relationship with an account of the second user. When one user logs in to an account of the user by using one smart device, it may indicate that there is a binding relationship between the user and the smart device.

The interaction circle includes smart devices which are corresponding to a user social circle and which are under different users. For example, assuming that User 1 includes Smart Device 1 and Smart Device 2, User 2 includes Smart Device 3 and Smart Device 4, User 3 includes Smart Device 5 and Smart Device 6, User 4 includes Smart Device 7 and Smart Device 8, User 5 includes Smart Device 9 and Smart Device 10, User 6 includes Smart Device 11 and Smart Device 12, and User 7 includes Smart Device 13, moreover, User 1, User 2, and User 3 may form a user social circle, User 1, User 4, and User 5 may form a user social circle, User 2, User 3, and User 6 may form a user social circle, User 4, User 5, and User 7 may form a user social circle, then a relationship among the smart devices under the users, the user social circles and the interaction circles may be shown in FIG. 1B. Specifically, Interaction Circle 1 may include Smart Device 1 under User 1, Smart Device 3 under User 2, and Smart Device 5 under User 3; Interaction Circle 2 may include Smart Device 2 under User 1, Smart Device 7 under User 4, and Smart Device 9 under User 5; Interaction Circle 3 may include Smart Device 4 under User 2, Smart Device 6 under User 3, and Smart Device 11 and Smart Device 12 under User 6; Interaction Circle 4 may include Smart Devices 7 and 8 under User 4, Smart Devices 9 and 10 under User 5, and Smart Device 13 under User 7.

It should be noted that, description is made in FIG. 1B where the same user is corresponding to different smart devices in different user social circles, but in different user social circles, there also may be the same smart device under the same user, which is not limited in the present disclosure.

It should be noted that there may one or more smart devices in one interaction circle for one user, which is not limited in the present disclosure.

Optionally, the user social circle may be specifically a family social circle reflecting a family relationship, or a work social circle reflecting a work relationship.

It should be noted that a smart device under one user may be in one or more interaction circles, respectively. For example, a smart device under User 1 in FIG. 1B may be in three interaction circles, respectively; and the smart devices under User 2, User 3, User 4, and User 5 are respectively in two interaction circles; and the smart devices under User 6 and User 7 are in one interaction circle. Optionally, the maximum number for interaction circles of a smart device under one user may be limited, for example, the maximum number may be 3, that is, the smart device under one user may be in up to three interaction circles, respectively.

Optionally, the smart device may include one or more of: a smart phone, a smart refrigerator, a smart speaker, and the like. Among them, the smart speaker may be, for example, a smart speaker with a display screen.

FIG. 2 is a flowchart illustrating a first embodiment of a smart interaction method according to an embodiment of the present disclosure. The executer of the method of the present embodiment may be a first smart device. As shown in FIG. 2, the method of the present embodiment may include:

Step 201, a first smart device receives an interaction request input by a first user, where the interaction request is used to request the first smart device under the first user in an interaction circle to interact with a second smart device under a second user in the interaction circle.

In this step, the interaction circle includes smart devices which are corresponding to a user social circle and which are under different users, and the same user corresponds to different smart devices in different user social circles.

For example, as shown in FIG. 1B, assuming that the first user is User 1, the first smart device is Smart Device 1, the second user is User 2, and the interaction circle is Interaction Circle 1, then User 1 may request Smart Device 1 to interact with Smart Device 3 under User 2 in Interaction Circle 1. Here, Smart Device 1 may not interact with Smart Device 4 under User 2 in Interaction Circle 3, and Smart Device 3 may not interact with Smart Device 2 under User 1 in Interaction Circle 2. Smart Device 3 may be perceived as the second smart device.

For another example, as shown in FIG. 1B, assuming that the first user is User 3, the first smart device is Smart Device 6, the second user is User 6, and the interaction circle is Interaction Circle 3, then User 3 may request Smart Device 6 to interact with Smart Device 11 and Smart Device 12 under User 6 in Interaction Circle 3. Here, Smart Device 11 and Smart Device 12 may not interact with Smart Device 5 under User 3 in Interaction Circle 1. Any one or two of Smart Device 11 and Smart Device 12 may be perceived as the second smart device. That is, there may be one or more second smart devices, and the first user may request a first smart device in an interaction circle to establish an interactive connection with one or more smart devices under a second user in the interaction circle. Interaction privacy may be further improved in the case that the first user may request a first smart device in an interaction circle to interact with a smart device under a second user in the interaction circle; and interaction convenience may be further improved in the case that the first user may request a first smart device in an interaction circle to establish an interactive connection with more than one smart device under a second user in the interaction circle.

It can be seen that an interaction between smart devices is not completely dependent on a user connection, but is related to the interaction circle. A smart user device under a first user in an interaction circle may interact with a smart device under a second user in the interaction circle, instead of interacting with a smart device under a second user outside the interaction circle.

It should be noted that a specific form of the interaction request is not limited in the present disclosure, which may be, for example, an interaction request in a voice form, an interaction request in a text form, an interaction request in a touch form, or the like.

Step 202, the first smart device establishes an interactive connection with the second smart device according to the interaction request.

In this step, optionally, the first smart device may establish an interactive connection with the second smart device according to the interaction request by using an interactive server that provides interactive connection support. The interactive server may be, for example, a video call server, an audio call server, or the like.

Optionally, in order to implement management from a cloud server for an interaction, optionally, before Step 202, the following may be further included: the first smart device transmits an interaction request to the cloud server, and performs Step 202 after receiving an interaction instruction transmitted by the cloud server. The cloud server may process the interaction request, e.g., perform verification and so on. In the embodiment of the present disclosure, the cloud server may be specifically a server for managing an interaction of a smart device.

It should be noted that the interactive connection may be a voice connection, a video connection, or the like, which is not limited in the present disclosure.

The smart interaction method provided in the embodiment of the present disclosure allows a first smart device to receive an interaction request input by a first user, where the interaction request is used to request the first smart device under the first user in an interaction circle to interact with a second smart device under a second user in the interaction circle, and the interaction circle includes smart devices which are corresponding to a user social circle and which are under different users; and allows the first smart device to establish an interactive connection with the second smart device according to the interaction request, so that an interaction between smart devices is not completely dependent on a user connection, but is related to the interaction circle. Specifically, a smart user device under a first user in an interaction circle may interact with a smart device under a second user in the interaction circle, instead of interacting with a smart device under a second user outside the interaction circle, thereby improving interaction privacy.

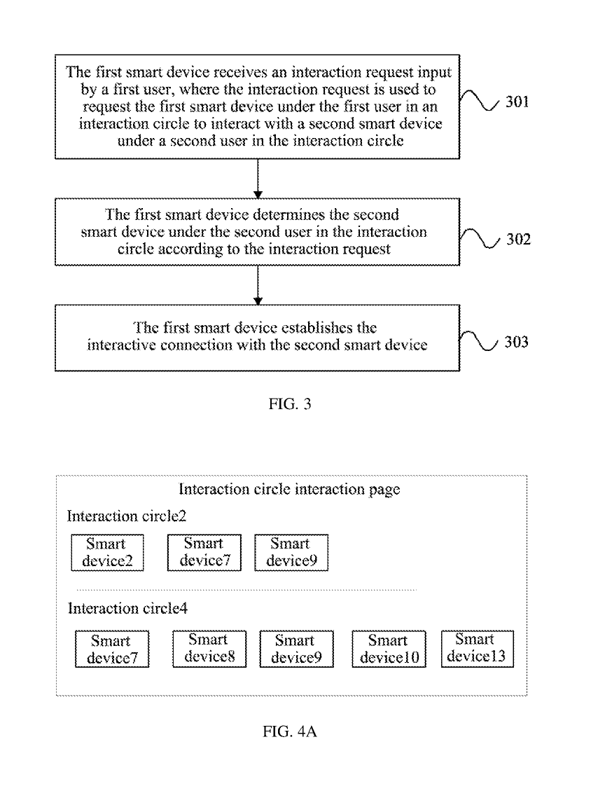

FIG. 3 is a flowchart illustrating a second embodiment of a smart interaction method according to an embodiment of the present disclosure. On the basis of the embodiment shown in FIG. 2, the present embodiment mainly describes an optional implementation in which the first smart device establishes an interactive connection with the second smart device according to the interaction request. As shown in FIG. 3, the method in the present embodiment may include:

Step 301, the first smart device receives an interaction request input by a first user, where the interaction request is used to request the first smart device under the first user in an interaction circle to interact with a second smart device under a second user in the interaction circle.

In this step, optionally, the interaction request includes: an identifier of the second user and an identifier of the interaction circle. Here, through the circumstance that the interaction request includes an identifier of the second user and an identifier of the interaction circle, a request to interact with a smart device under a second user in the interaction circle may be indicated.

Optionally, the first smart device may receive the interaction request input by the first user through an interaction page. The interaction page may be, for example, an Application Program (APP) page or the like. Further optionally, the first smart device receives the interaction request input by the first user on an interaction circle interaction page, where the interaction circle interaction page is a page that provides the user with a function for an interaction between the smart devices in the interaction circle.

Optionally, in the embodiment of the present disclosure, the interaction page provided by the first smart device to the first user may match the interaction circle to which the first smart device under the first user belongs. Specifically, the interaction circle interaction page provided by the first smart device to the first user may correspond to the interaction circle to which the first smart device under the first user belongs. Here, the interaction page provided by the first smart device to the first user may match the interaction circle to which the first smart device under the first user belongs, through which content of information on the interaction page may be reduced, and the interaction page may be simplified, thereby improving user interaction experience.

Optionally, when a smart device in the interaction circle is displayed to the user, a device name and/or a device type of the smart device may be displayed.

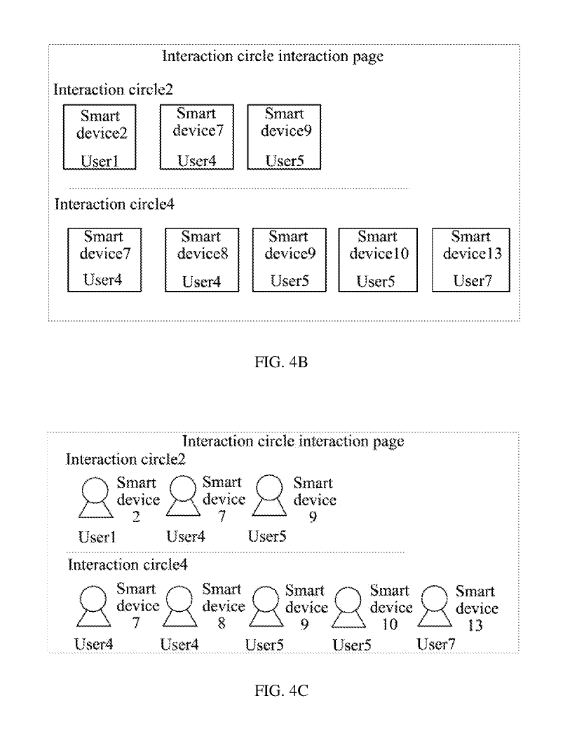

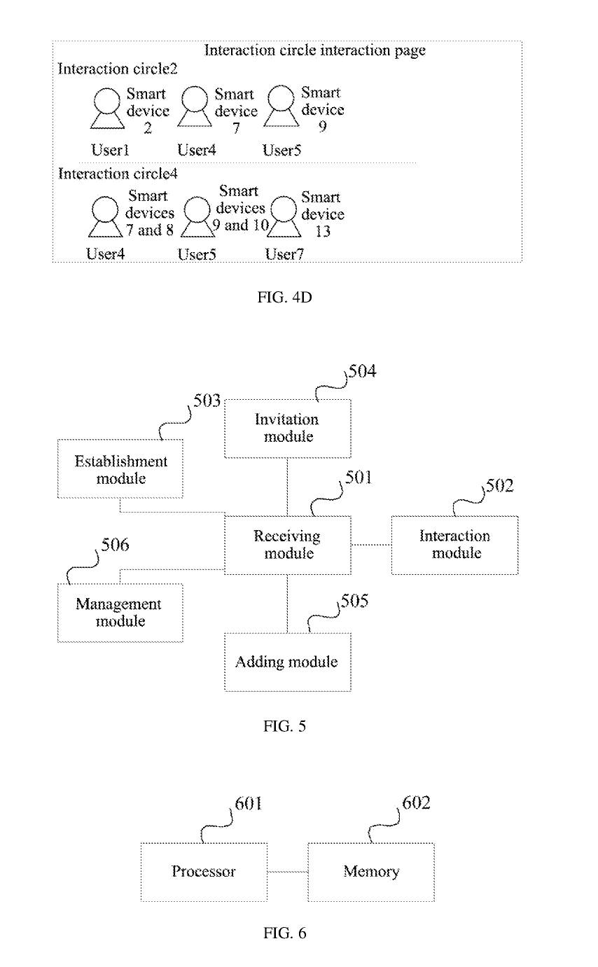

For example, on the basis of FIG. 1B, assuming that the first user is User 4 and the first smart device is Smart Device 7, then an interaction circle interaction page for the first smart device may be, for example, as shown in FIG. 4A, further, when User 4 selects Smart Device 2, it may be indicated that Smart Device 7 requests to interact with Smart Device 2 under User 1 in Interaction Circle 2. Further optionally, in order to facilitate determination of the user, FIG. 4A may be improved to prompt to the user a user corresponding to the smart device, and an improvement result is, for example, as shown in FIG. 4B. Further optionally, in order to further facilitate determination of the user to prompt the user an avatar of a user corresponding to the smart device, FIG. 4B may be improved, and an improvement result may be, for example, as shown in FIG. 4C. Further, when User 4 selects an avatar corresponding to Smart Device 2, it may be indicated that Smart Device 7 requests to interact with Smart Device 2 under User 1 in Interaction Circle 2. Further optionally, when second smart user devices under the second user may be more than one in quantity, in order to facilitate establishment of interactive connections with more than one second smart device, the more than one second smart device may be uniformly displayed, thus FIG. 4C may be improved, an improvement result may be, for example, as shown in FIG. 4D. Further, when User 4 selects an avatar corresponding to User 5, it may be indicated that Smart Device 7 requests to interact with Smart Device 8 and Smart Device 10 under User 5 in Interaction Circle 4.

It should be noted that, in FIG. 4A to FIG. 4D, description is made by taking an example where a device name of a smart device* is the smart device*, and a name of a user* is the user*. Optionally, representations of device types of the smart devices may also be added in FIG. 4A to FIG. 4D. For example, icons corresponding to the device types of the smart devices may also be added in FIG. 4A to FIG. 4D.

Optionally, the first user may enter an interaction circle interaction page through an entry for the interaction circle interaction page provided by a homepage of the interaction page. The homepage of the interaction page may be, for example, a homepage of the APP.

Optionally, an entry for an additional interaction page may be provided on the interaction circle interaction page, such as one or more of an entry for an interaction circle management page, an entry for an interaction circle invitation page, an entry for an interaction circle application page, or an entry for an interaction circle establishment page.

Optionally, for smart devices in one interaction circle of the interaction circle interaction page, the smart devices may be sorted from left to right according to a chronological order in which the smart devices join the interaction circle.

Optionally, in more than one interaction circle of the interaction circle interaction page, an interaction circle which is created by a user itself and in which members have been invited may be topped, interaction circles which are not created by the user itself may be sequentially queued after the interaction circle which is created by the user itself and in which members have been invited according to a chronological order of joining the interaction circle, and an interaction circle which is created by the user itself and in which no member has been invited may be ranked last. The members here may be interpreted as smart devices.

Step 302, the first smart device determines the second smart device under the second user in the interaction circle according to the interaction request.

In this step, optionally, the first smart device may be stored with a correspondence between a smart device and a user in each interaction circle to which the first smart device belongs, and may further determine the second smart device according to an identifier of the second user and an identifier of the interaction circle that are included in the interaction request; alternatively, the first smart device may transmit the interaction request to a cloud server, and receive indication information returned by the cloud server according to the correspondence between the smart device and the user in each interaction circle to which the first smart device belongs and the interaction request, where the indication information is used to indicate the second smart device; alternatively, the interaction request may further include an identifier of the second smart device, and the first smart device may determine the second smart device according to the interaction request only.

Step 303, the first smart device establishes the interactive connection with the second smart device.

In this step, optionally, the first smart device may establish the interactive connection with the second smart device according to the interaction request by using an interactive server that provides interactive connection support. The interactive server may be, for example, a video call server, an audio call server, or the like.

The smart interaction method provided in the present embodiment allows the first smart device to receive an interaction request input by a first user, where the interaction request includes an identifier of the second user and an identifier of the interaction circle; allows the first smart device to determine the second smart device under the second user in the interaction circle according to the interaction request; and allows the first smart device to establish the interactive connection with the second smart device, so that the interactive connection with the second smart device is established by the first smart according to the interaction request.

Optionally, in the foregoing embodiment, the interaction circle may be established by the first user using the first smart device. Further optionally, before the first smart device receives the interaction request input by the first user, the following steps may be further included:

the first smart device receives an establishment request input by the first user, where the establishment request is used to apply for establishing the interaction circle; and

the first smart device establishes the interaction circle according to the establishment request.

Optionally, the establishment request may include an identifier of the interaction circle, such as a name of the interaction circle, a QR code of the interaction circle, a number of the interaction circle, and the like. When the identifier of the interaction circle is not included in the establishment request, the name of the interaction circle may be a default name, such as “my interaction circle”.

Optionally, the first smart device establishes the interaction circle according to the establishment request, which may specifically include: the first smart device transmits, according to the establishment request, a request message for requesting establishment of the interaction circle to a cloud server; the cloud server may create the interaction circle according to the request message, and return a response message to the first smart device after it saves a correspondence between the first smart device and the first user in the interaction circle; and the first smart device may determine the correspondence between the first smart device and the first user in the interaction circle according to the response message. Further optionally, the first smart device may jump to the display of the interaction circle interaction page on which the interaction circle is updated.

Similar to the interaction circle interaction page, optionally, the first smart device receives the establishment request input by the first user, including:

The first smart device receives an establishment request input by the first user on an interaction circle establishment page, where the interaction circle establishment page is a page that provides the user with a function for establishing the interaction circle.

Optionally, an entry for the interaction circle application page may be provided in the interaction circle establishment page.

Optionally, after the first smart device establishes the interaction circle according to the establishment request, the following steps may be further included:

the first smart device receives an invitation request input by the first user, where the invitation request includes an identifier of the second smart device, and the invitation request is used to invite the second smart device to join the interaction circle; and

the first smart device invites, according to the invitation request, the second smart device to join the interaction circle.

Optionally, the invitation request may include an identifier of the second smart device, or the invitation request may include an identifier of the interaction circle. The identifier of the second smart device may be, for example, Xiaodu's number of the second smart device.

Further optionally, when the invitation request includes an identifier of the second smart device, the second smart device may be invited to join the interaction circle by requesting the second smart device under the second user to make verification. Correspondingly, the first smart device invites, according to the invitation request, the second smart device to join the interaction circle, which may include: the first smart device may transmit the identifier of the second smart device to a cloud server, acquire information on a user corresponding to the second smart device from the cloud server, and display the information on the user corresponding to the second smart device; the first smart device may initiate an invitation to the second smart device according to an initiating instruction input by the user (for example, an instruction to click an invitation button). Then, after the second smart device passes the verification, the first smart device may jump to the display of the interaction circle interaction page on which the interaction circle is updated, that is, the second smart device has been added to the interaction circle.

Optionally, when the second smart device is a smart phone, the acquiring the information on the user corresponding to the second smart device from the cloud server may specifically include: displaying an avatar and a user name of the second user; and when the second smart device is a smart speaker, the acquiring the information on the user corresponding to the second smart device from the cloud server may specifically include: displaying a default icon of the second smart device and a device name of the second smart device.

Further optionally, when the invitation request includes an identifier of the interaction circle, the second smart device may be invited to join the interaction circle by sharing the identifier of the interaction circle to the second smart device under the second user and applying by the second smart device under the second user. Correspondingly, the first smart device invites, according to the invitation request, the second smart device to join the interaction circle, which may include: the first smart device shares the identifier of the interaction circle to the second smart device.

Similar to the interaction circle interaction page, optionally, the first smart device receives the invitation request input by the first user, including:

the first smart device receives an invitation request input by the first user on an interaction circle invitation page, where the interaction circle invitation page is a page that provides the user with a function for inviting the smart device.

Optionally, a smart device search bar may be displayed on the interaction circle invitation page, and the user may input the identifier of the second smart device in the smart device search bar.

Optionally, a text indicator also may be displayed on the interaction circle invitation page. For example, in the vicinity of the identifier of the interaction circle, the user may be indicated that “please share this number, and the other party may join in upon application and verification”. For another example, after the user inputs a first initiating instruction, the user may be indicated that “an invitation has been initiated, and please wait for the other party to verify”. For another example, when the identifier of the smart device input by the user in the smart device search bar is incorrect in form or the input is empty, the user may be indicated that “please input a correct number for Xiaodu”. For another example, when the identifier of the smart device already existing in the interaction circle is input in the smart device search bar, the user may be indicated that “the device has already joined the interaction circle”.

Optionally, the first user may apply for the first smart device to join the interaction circle. Further, before the first smart device receives the interaction request input by the first user, the following steps may be further included:

the first smart device receives an application request input by the first user, where the application request includes an identifier of the interaction circle, and the application request is used to request the first smart device to join the interaction circle; and

the first smart device adds the first smart device to the interaction circle according to the application request.

Optionally, the first smart device adds the first smart device to the interaction circle according to the application request, which may specifically include: the first smart device may transmit an identifier of the interaction circle to a cloud server, acquire information on the interaction circle corresponding to the identifier of the interaction circle from the cloud server, and display the information on the interaction circle corresponding to the identifier of the interaction circle; the first smart device may initiate, according to a second initiating instruction input by the user (for example, an instruction to click an application button), an application to the smart device under the user who establishes the interaction circle. Then, after the smart device under the user who establishes the interaction circle passes verification, the first smart device may jump to the display of the interaction circle management page, that is, the first smart device has been added to the interaction circle.

Similar to the interaction circle interaction page, optionally, the first smart device receives the application request input by the first user, including:

the first smart device receives an application request input by the first user on an interaction circle application page, where the interaction circle application page is a page that provides the user with a function for adding the smart device to the interaction circle.

Optionally, an interaction circle search bar may be displayed on the interaction circle application page, and the user may input the identifier of the interaction circle in the interaction circle search bar.

Optionally, a text indicator also may be displayed on the interaction circle application page. For example, a step description of the application may be indicated to the user in the vicinity of the interaction circle search bar. For another example, after the user inputs a second initiating instruction, the user may be indicated that “an application has been made and please wait for the other party to verify”. For another example, when the number of the interaction circle input by the user in the interaction circle search bar is incorrect in form, the user may be indicated that “please input the correct number”. For another example, when the number of the interaction circle input by the user in the interaction circle search bar does not exist, the user may be indicated that “the number does not exist”.

Optionally, based on the foregoing embodiment, the following steps may be further included:

the first smart device receives a management request input by the first user, where the management request is used to request management of the interaction circle; and

the first smart device manages the interaction circle according to the management request.

Optionally, the management request may be specifically used to: modify the device name of the first smart device; modify the name of the interaction circle established by the first smart device under the first user; dismiss the interaction circle established by the first smart device under the first user; remove smart devices in the interaction circle established by the first smart device under the first user; and the like.

Optionally, the first smart device manages the interaction circle according to the management request, including: the first smart device transmits the management request to a cloud server, and the cloud server updates, according to the management request, a stored correspondence between the smart device and the user in each interaction circle to which the first smart device belongs, and returns a response message to the first smart device, where the response message may include an updated result of the correspondence. The first smart device may perform further processing according to the response message, for example, update a locally stored correspondence between the smart device and the user in each interaction circle to which the first smart device belongs, or update the display of the interaction circle interaction page, or the like.

Similar to the interaction circle interaction page, optionally, the first smart device receives the management request input by the first user, including:

the first smart device receives a management request input by the first user on an interaction circle management page, where the interaction circle management page is a page that provides the user with a function for managing the interaction circle.

Optionally, an entry for the interaction circle invitation page may be provided on the interaction circle management page.

Optionally, the interaction circle management page includes a multi-level management page, for example, may include a two-level management page. For example, a device name and a device type of the smart device included in the interaction circle may be displayed on a first-level management page. When the user selects the device name of the smart device, an interface for setting the device name of the smart device may be displayed on a second-level management page.

FIG. 5 is a schematic structural diagram illustrating an embodiment of smart interaction apparatus according to an embodiment of the present disclosure. The apparatus provided in the present embodiment may be applied to the foregoing method embodiments to implement functions of the first smart device. As shown in FIG. 5, the apparatus in the present embodiment may include: a receiving module 501, and an interaction module 502,

where the receiving module 501 is configured to receive an interaction request input by a first user, where the interaction request is used to request the first smart device under the first user in an interaction circle to interact with a second smart device under a second user in the interaction circle, and the interaction circle includes smart devices which are corresponding to a user social circle and which are under different users; and

the interaction module 502 is configured to establish an interactive connection with the second smart device according to the interaction request.

In a possibly implemented design, the interaction request includes: an identifier of the second user and an identifier of the interaction circle;

the interaction module 502 is specifically configured to:

determine the second smart device under the second user in the interaction circle according to the interaction request; and establish the interactive connection with the second smart device.

In a possibly implemented design, the receiving module 501 is specifically configured to:

receive an interaction request input by the first user on an interaction circle interaction page, where the interaction circle interaction page is a page that provides the user with a function for an interaction between the smart devices in the interaction circle.

In a possibly implemented design, the receiving module 501 is further configured to receive an establishment request input by the first user, where the establishment request is used to apply for establishing the interaction circle;

the apparatus provided in the present embodiment further includes: an establishment module 503, configured to establish the interaction circle according to the establishment request.

In a possibly implemented design, the receiving module 501 is configured to receive the establishment request input by the first user, specifically including:

receiving an establishment request input by the first user on an interaction circle establishment page, where the interaction circle establishment page is a page that provides the user with a function for establishing the interaction circle.

In a possibly implemented design, the receiving module 501 is further configured to receive an invitation request input by the first user, where the invitation request includes an identifier of the second smart device, and the invitation request is used to invite the second smart device to join the interaction circle;

the apparatus provided in the present embodiment further includes: an invitation module 504, configured to invite, according to the invitation request, the second smart device to join the interaction circle.

In a possibly implemented design, the receiving module 501 is configured to receive the invitation request input by the first user, specifically including:

receiving an invitation request input by the first user on an interaction circle invitation page, where the interaction circle invitation page is a page that provides the user with a function for inviting the smart device.

In a possibly implemented design, the receiving module 501 is further configured to receive an application request input by the first user, where the application request includes an identifier of the interaction circle, and the application request is used to request the first smart device to join the interaction circle;

the apparatus provided in the present embodiment further includes: an adding module 505, configured to add the first smart device to the interaction circle according to the application request.

In a possibly implemented design, the receiving module 501 is configured to receive the application request input by the first user, specifically including:

receiving an application request input by the first user on an interaction circle application page, where the interaction circle application page is a page that provides the user with a function for adding the smart device to the interaction circle.

In a possibly implemented design, the receiving module 501 is further configured to receive a management request input by the first user, where the management request is used to request management of the interaction circle;

the apparatus provided in the present embodiment further includes: a management module 506, configured to manage the interaction circle according to the management request.

In a possibly implemented design, the receiving module 501 is configured to receive the management request input by the first user, specifically including:

receiving a management request input by the first user on an interaction circle management page, where the interaction circle management page is a page that provides the user with a function for managing the interaction circle.

The apparatus in the present embodiment may be used to implement the technical solutions of the embodiments shown in the foregoing method, and implementation principles and technical effects thereof are similar, for which details will be omitted herein.

FIG. 6 is a schematic structural diagram of a smart device according to an embodiment of the present disclosure. The smart device is the first smart device described above. As shown in FIG. 6, the smart device may include: a processor 601 and a memory 602 for storing computer instructions.

The processor 601 executes the computer instructions to perform the following method:

receiving an interaction request input by a first user, where the interaction request is used to request the first smart device under the first user in an interaction circle to interact with a second smart device under a second user in the interaction circle, and the interaction circle includes smart devices which are corresponding to a user social circle and which are under different users, moreover, the same user corresponds to different smart devices in different user social circles; and

establishing an interactive connection with the second smart device according to the interaction request.

In a possibly implemented design, the interaction request includes: an identifier of the second user and an identifier of the interaction circle; and the establishing the interactive connection with the second smart device according to the interaction request includes:

determining the second smart device under the second user in the interaction circle according to the interaction request; and

establishing the interactive connection with the second smart device.

In a possibly implemented design, the receiving the interaction request input by the first user includes:

receiving an interaction request input by the first user on an interaction circle interaction page, where the interaction circle interaction page is a page that provides the user with a function for an interaction between the smart devices in the interaction circle.

In a possibly implemented design, before receiving the interaction request input by the first user, further including:

receiving an establishment request input by the first user, where the establishment request is used to apply for establishing the interaction circle; and

establishing the interaction circle according to the establishment request.

In a possibly implemented design, the receiving the establishment request input by the first user includes:

receiving an establishment request input by the first user on an interaction circle establishment page, where the interaction circle establishment page is a page that provides the user with a function for establishing the interaction circle.

In a possibly implemented design, after establishing the interaction circle according to the establishment request, further including:

receiving an invitation request input by the first user, where the invitation request includes an identifier of the second smart device, and the invitation request is used to invite the second smart device to join the interaction circle; and

inviting, according to the invitation request, the second smart device to join the interaction circle.

In a possibly implemented design, the receiving the invitation request input by the first user includes:

receiving an invitation request input by the first user on an interaction circle invitation page, where the interaction circle invitation page is a page that provides the user with a function for inviting the smart device.

In a possibly implemented design, before receiving the interaction request input by the first user, further including:

receiving an application request input by the first user, where the application request includes an identifier of the interaction circle, and the application request is used to request the first smart device to join the interaction circle; and

adding the first smart device to the interaction circle according to the application request.

In a possibly implemented design, the receiving the application request input by the first user includes:

receiving an application request input by the first user on an interaction circle application page, where the interaction circle application page is a page that provides the user with a function for adding the smart device to the interaction circle.

In a possibly implemented design, the method further includes:

receiving a management request input by the first user, where the management request is used to request management of the interaction circle; and

managing the interaction circle according to the management request.

In a possibly implemented design, the receiving the management request input by the first user includes:

receiving a management request input by the first user on an interaction circle management page, where the interaction circle management page is a page that provides the user with a function for managing the interaction circle.

An embodiment of the present disclosure further provides a computer readable storage medium, when instructions in the storage medium are executed by a processor of a first smart device, the first smart device is able to perform a smart interaction method including steps of:

receiving an interaction request input by a first user, where the interaction request is used to request the first smart device under the first user in an interaction circle to interact with a second smart device under a second user in the interaction circle, and the interaction circle includes smart devices which are corresponding to a user social circle and which are under different users, moreover, the same user corresponds to different smart devices in different user social circles; and

establishing an interactive connection with the second smart device according to the interaction request.

In a possibly implemented design, the interaction request includes: an identifier of the second user and an identifier of the interaction circle; and the establishing the interactive connection with the second smart device according to the interaction request includes:

determining the second smart device under the second user in the interaction circle according to the interaction request; and

establishing the interactive connection with the second smart device.

In a possibly implemented design, the receiving the interaction request input by the first user includes:

receiving an interaction request input by the first user on an interaction circle interaction page, where the interaction circle interaction page is a page that provides the user with a function for an interaction between the smart devices in the interaction circle.

In a possibly implemented design, before receiving the interaction request input by the first user, further including:

receiving an establishment request input by the first user, where the establishment request is used to apply for establishing the interaction circle; and

establishing the interaction circle according to the establishment request.

In a possibly implemented design, the receiving the establishment request input by the first user includes:

receiving an establishment request input by the first user on an interaction circle establishment page, where the interaction circle establishment page is a page that provides the user with a function for establishing the interaction circle.

In a possibly implemented design, after establishing the interaction circle according to the establishment request, further including:

receiving an invitation request input by the first user, where the invitation request includes an identifier of the second smart device, and the invitation request is used to invite the second smart device to join the interaction circle; and

inviting, according to the invitation request, the second smart device to join the interaction circle.

In a possibly implemented design, the receiving the invitation request input by the first user includes:

receiving an invitation request input by the first user on an interaction circle invitation page, where the interaction circle invitation page is a page that provides the user with a function for inviting the smart device.

In a possibly implemented design, before receiving the interaction request input by the first user, further including:

receiving an application request input by the first user, where the application request includes an identifier of the interaction circle, and the application request is used to request the first smart device to join the interaction circle; and

adding the first smart device to the interaction circle according to the application request.

In a possibly implemented design, the receiving the application request input by the first user includes:

receiving an application request input by the first user on an interaction circle application page, where the interaction circle application page is a page that provides the user with a function for adding the smart device to the interaction circle.

In a possibly implemented design, the method further includes:

receiving a management request input by the first user, where the management request is used to request management of the interaction circle; and

managing the interaction circle according to the management request.

In a possibly implemented design, the receiving the management request input by the first user includes:

receiving a management request input by the first user on an interaction circle management page, where the interaction circle management page is a page that provides the user with a function for managing the interaction circle.

Persons of ordinary skill in the art may understand that, all or a part of the steps of the foregoing method embodiments may be implemented by a program instructing relevant hardware. The foregoing program may be stored in a computer readable storage medium. When the program runs, the steps of the foregoing method embodiments are performed. The foregoing storage medium includes various mediums capable of storing program codes, such as an ROM, an RAM, a magnetic disk, or an optical disc.

Finally, it should be noted that the foregoing embodiments are merely intended for describing the technical solutions of the present disclosure rather than limiting the present disclosure. Although the present disclosure is described in detail with reference to the foregoing embodiments, persons of ordinary skill in the art should understand that they may still make modifications to the technical solutions described in the foregoing embodiments, or make equivalent replacements to some or all technical features therein; however, these modifications or replacements do not make the essence of corresponding technical solutions depart from the scope of the technical solutions in the embodiments of the present disclosure.

What is claimed is:

1. A smart interaction method performed by a first smart device, comprising:
receiving an interaction request input by a first user, wherein the interaction request is used to request the first smart device under the first user in an interaction circle to interact with a second smart device under a second user in the interaction circle, and the interaction circle comprises smart devices which are corresponding to a user social circle and which are under different users; and
establishing an interactive connection with the second smart device according to the interaction request.

2. The method according to claim 1, wherein the interaction request comprises:
an identifier of the second user and an identifier of the interaction circle; and the establishing the interactive connection with the second smart device according to the interaction request comprises:
determining the second smart device under the second user in the interaction circle according to the interaction request; and
establishing the interactive connection with the second smart device.

3. The method according to claim 1, wherein the receiving the interaction request input by the first user comprises:
receiving an interaction request input by the first user on an interaction circle interaction page, wherein the interaction circle interaction page is a page that provides the user with a function for an interaction between the smart devices in the interaction circle.

4. The method according to claim 1, before receiving the interaction request input by the first user, further comprising:
receiving an establishment request input by the first user, wherein the establishment request is used to apply for establishing the interaction circle; and
establishing the interaction circle according to the establishment request.

5. The method according to claim 4, wherein the receiving the establishment request input by the first user comprises:
receiving an establishment request input by the first user on an interaction circle establishment page, wherein the interaction circle establishment page is a page that provides the user with a function for establishing the interaction circle.

6. The method according to claim 4, after establishing the interaction circle according to the establishment request, further comprising:
receiving an invitation request input by the first user, wherein the invitation request comprises an identifier of the second smart device, and the invitation request is used to invite the second smart device to join the interaction circle; and
inviting, according to the invitation request, the second smart device to join the interaction circle.

7. The method according to claim 6, wherein the receiving the invitation request input by the first user comprises:
receiving an invitation request input by the first user on an interaction circle invitation page, wherein the interaction circle invitation page is a page that provides the user with a function for inviting a smart device.

8. The method according to claim 1, before receiving the interaction request input by the first user, further comprising:
receiving an application request input by the first user, wherein the application request comprises an identifier of the interaction circle, and the application request is used to request the first smart device to join the interaction circle; and
adding the first smart device to the interaction circle according to the application request.

9. The method according to claim 8, wherein the receiving the application request input by the first user comprises:
receiving an application request input by the first user on an interaction circle application page, wherein the interaction circle application page is a page that provides the user with a function for adding a smart device to the interaction circle.

10. The method according to claim 1, further comprising:
receiving a management request input by the first user, wherein the management request is used to request management of the interaction circle; and
managing the interaction circle according to the management request.

11. A smart interaction apparatus applied to a first smart device, comprising a processor and a computer-readable medium for storing program codes, which, when executed by the processor, cause the processor to:
receive an interaction request input by a first user, wherein the interaction request is used to request the first smart device under the first user in an interaction circle to interact with a second smart device under a second user in the interaction circle, and the interaction circle comprises smart devices which are corresponding to a user social circle and which are under different users; and
establish an interactive connection with the second smart device according to the interaction request.

12. The apparatus according to claim 11, wherein the interaction request comprises: an identifier of the second user and an identifier of the interaction circle; and
the program codes further cause the processor to:
determine the second smart device under the second user in the interaction circle according to the interaction request; and establish the interactive connection with the second smart device.

13. The apparatus according to claim 11, wherein the program codes further cause the processor to::
receive an interaction request input by the first user on an interaction circle interaction page, wherein the interaction circle interaction page is a page that provides the user with a function for an interaction between the smart devices in the interaction circle.

14. The apparatus according to claim 11, wherein the program codes further cause the processor to:
receive an establishment request input by the first user, wherein the establishment request is used to apply for establishing the interaction circle; and
establish the interaction circle according to the establishment request.

15. The apparatus according to claim 14, wherein the program codes further cause the processor to:
receive an establishment request input by the first user on an interaction circle establishment page, wherein the interaction circle establishment page is a page that provides the user with a function for establishing the interaction circle.

16. The apparatus according to claim 14, wherein the program codes further cause the processor to:
receive an invitation request input by the first user, wherein the invitation request comprises an identifier of the second smart device, and the invitation request is used to invite the second smart device to join the interaction circle; and
invite, according to the invitation request, the second smart device to join the interaction circle.

17. The apparatus according to claim 16, wherein the program codes further cause the processor to:
receive an invitation request input by the first user on an interaction circle invitation page, wherein the interaction circle invitation page is a page that provides the user with a function for inviting a smart device.

18. The apparatus according to claim 11, wherein the program codes further cause the processor to:
receive an application request input by the first user, wherein the application request comprises an identifier of the interaction circle, and the application request is used to request the first smart device to join the interaction circle; and
add the first smart device to the interaction circle according to the application request.

19. The apparatus according to claim 18, wherein the program codes further cause the processor to:
receive an application request input by the first user on an interaction circle application page, wherein the interaction circle application page is a page that provides the user with a function for adding a smart device to the interaction circle.

20. The apparatus according to claim 11, wherein the program codes further cause the processor to:
receive a management request input by the first user, wherein the management request is used to request management of the interaction circle; and
manage the interaction circle according to the management request.
